(19) United States
(12) Patent Application Publication
(10) Pub. No.: US 2019/0104568 A1
(43) Pub. Date: Apr. 4, 2019

(54) SELF-REGULATING HEATER COMPENSATION

(71) Applicant: Rosemount Aerospace Inc., Burnsville, MN (US)

(72) Inventor: William B. Krueger, Bloomington, MN (US)

(21) Appl. No.: 15/720,340

(22) Filed: Sep. 29, 2017

(51) Int. Cl. H05B 3/14

(52) U.S. Cl. CPC H05B 3/141; G01K 7/25

(57) ABSTRACT

A heating system includes a voltage source, a heating circuit, and a current sensor. The voltage source is configured to provide a current. The heater circuit is electrically coupled to the voltage source. The heater circuit includes a heater array and a compensation circuit. The heater array is configured to provide heat to a region using the current. The compensation circuit is electrically coupled to the voltage source in parallel with the heater array. The compensation circuit is configured to maintain the current above a threshold current level when the heater array is operable. The current sensor is configured to measure a level of the current to the heater circuit and output an alert in response to the current falling below the threshold current level.

### BACKGROUND

Barium titanate electrical heater arrays are widely used in aircraft applications. Barium titanate heaters provide a simple and reliable alternative to electrical resistance heaters controlled with external electronic circuits. The self-regulating nature of barium titanate under operating conditions eliminates the need for external control circuits. Electrical resistance of barium titanate heaters increases dramatically at temperatures above a given set point temperature. A typical set point temperature would be 73 degrees Celsius as will be used herein. Temperatures above the set point cause rapid increases in the heater resistance, which in turn cause the current to drop significantly, preventing the barium titanate heater from overheating the local region.

### SUMMARY

In one example, a heating system comprises a voltage source, a heating circuit, and a current sensor. The voltage source is configured to provide a current. The heater circuit is electrically coupled to the voltage source. The heater circuit comprises a heater array and a compensation circuit. The heater array is configured to provide heat to a region using the current. The compensation circuit is electrically coupled to the voltage source in parallel with the heater array. The compensation circuit is configured to maintain the current above a threshold current level when the heater array is operable. The current sensor is configured to measure a level of the current to the heater circuit and output an alert in response to the current falling below the threshold current level.

In one example, a method comprises providing a current to a heater circuit using a voltage source including providing a first portion of the current to a heater array of the heater circuit; and providing a second portion of the current to a compensation circuit of the heater circuit connected in parallel to the heater array; heating a region using the heater array; adjusting, using the compensation circuit, the second portion of the current based on a temperature of the region, such that a sum of the first portion of the current and the second portion of the current corresponding to the current provided to the heater circuit is maintained above a threshold current level when the heater array is operable; and measuring the current using a current sensor.

### BRIEF DESCRIPTION OF THE DRAWINGS

FIG. 1 is a perspective view of an angle of attack sensor utilizing heating circuits.

FIG. 2 is a schematic diagram of a heating system including a compensation circuit.

FIG. 3 is a graph illustrating the change in resistance of a barium titanate heater array over temperature.

FIG. 4 is a flow diagram depicting a process for current compensation of a heater circuit.

### DETAILED DESCRIPTION

Apparatus, systems, and associated methods relate to self-regulating heater compensation using a compensation circuit electrically coupled to a heater circuit in parallel. In some applications, such as an aircraft sensor, self-regulating heater circuits are used on angle of attack sensors, side slip angle sensors, integral static port sensors, and/or other sensors of an aircraft. The self-regulating heater current is monitored to ensure proper operation and an alert is output when the current falls below a current threshold level. In hot environments, such as desert regions, self-regulating heaters may draw current that falls below the current threshold level, causing a false alarm. This can cause the aircraft to be grounded, wasting time and money. Using the apparatus, systems, and associated methods herein, allows for the compensation circuit to bring the current above the current threshold level when the self-regulating heater is in operable condition.

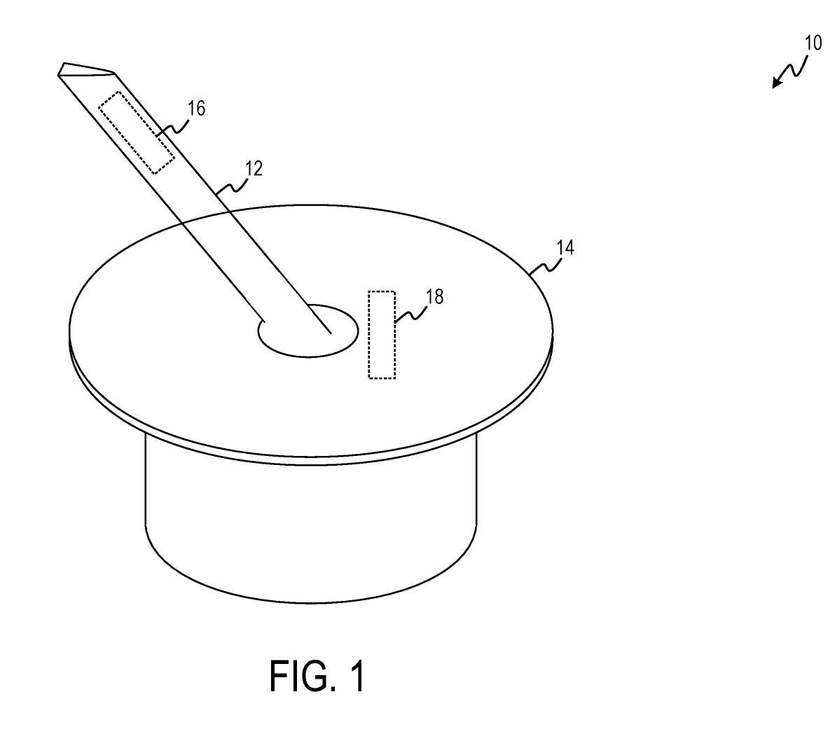

FIG. 1 is a perspective view of an angle of attack sensor 10 including vane 12, sensor housing 14, heating circuit 16, and heating circuit 18. Vane 12 rotates and aligns itself with a local airflow. Sensor housing 14 contains circuitry to compare the angle of vane 12 to a reference line to determine the local angle of attack. When angle of attack sensor 10 is exposed to freezing conditions, vane 12 and sensor housing 14 can accumulate ice, preventing vane 12 from rotating with the local airflow. When vane 12 cannot rotate, angle of attack sensor 10 will cease to provide an accurate measure of the local angle of attack. Heating circuits 16 and 18 are provided to prevent the accumulation of ice and the resulting inoperability of angle of attack sensor 10.

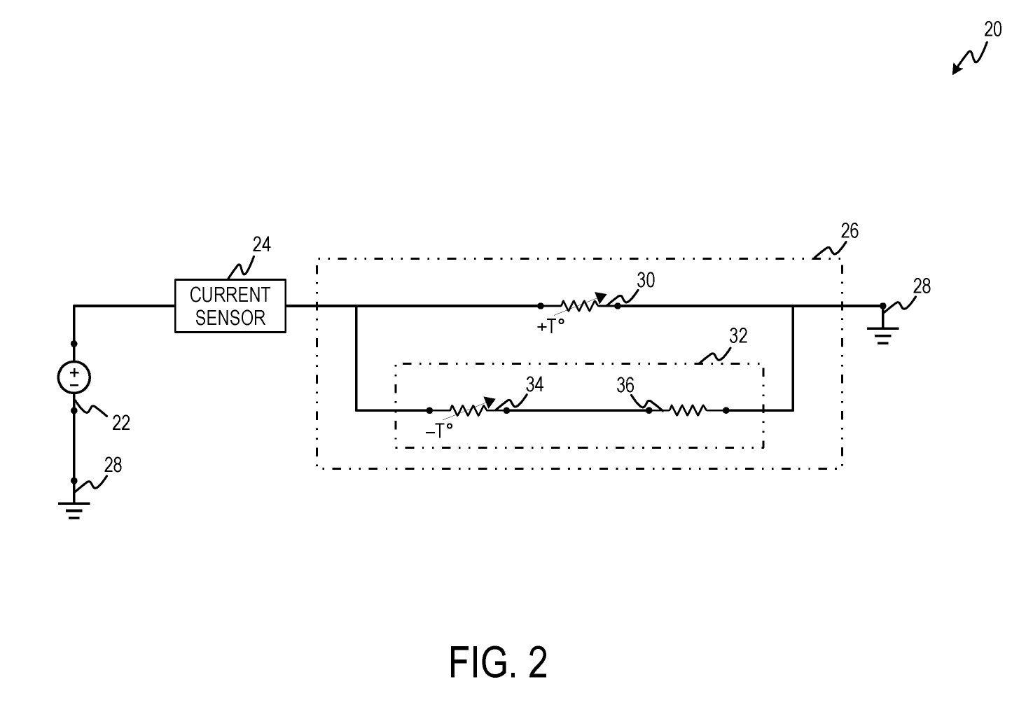

FIG. 2 is a schematic diagram of heating system 20 including voltage source 22, current sensor 24, heating circuit 26, and ground connections 28. Heating circuit 26 includes heater array 30 and compensation circuit 32. Compensation circuit 32 includes thermistor 34 and current limiting resistor 36. Heating circuit 26 can be representative of heater circuits 16 and 18 of FIG. 1.

Voltage source 22 provides current to heater circuit 26. Current sensor 24 measures the current provided to heater circuit 26. In one example, current sensor 24 is a shunt resistor. In a further example, current sensor 24 is an integrated circuit configured to sense the current provided to heater circuit 26. Current sensor 24 is configured to provide an alert if the current provided by voltage source 22 falls below a threshold current level. The current provided by voltage source 22 is determined by the total resistance of heater circuit 26. Heater circuit 26 includes heater array 30 electrically coupled in parallel to compensation circuit 32. A first portion of the current is provided to heater array 30, and a second portion of the current is provided to compensation circuit 32. Heater array 30 provides heat to a region using the first portion of the current provided by voltage source 22. In one example, heater array 30 is a barium titanate heater array.

As the resistance of heater array 30 increases, the first portion of the current provided by voltage source 22 decreases. High temperatures cause the resistance of heater array 30 to become so high that the first portion of the current falls below the threshold current level of sensor 24. Without additional current, sensor 24 will provide an alert. During high temperatures compensation circuit 32 is configured to increase current draw causing the second portion of the current to increase. The increase of the second portion of the current is sufficient to maintain the current supplied to heating circuit 20 above the threshold when heater array 30 is operative. However, the increase in the second portion of the circuit is insufficient to maintain the current above the threshold when heater array 30 is inoperative. Heater array 30 can become inoperative when damaged which causes the resistance of heater array 30 to increase beyond a typical range or become an open circuit. In some examples, the compensation circuit includes a thermistor and a current limiting resistor electrically coupled in series. The current limiting resistor is configured to limit the second portion of the current to be less than the current threshold level. In one example, the current limiting resistor is configured to limit the second portion of the current to half the current threshold limit. In one example, a resistance of the current limiting resistor is configured to remain substantially constant. Limiting the second portion of the current in this manner allows sensor 24 to provide an alert if heater array 30 becomes inoperable, such as failing in an open circuit condition, but still provides enough current to compensate for high temperature conditions. In one example, the thermistor is a negative temperature coefficient resistor. Negative temperature coefficient thermistors decrease in resistance as the temperature increases.

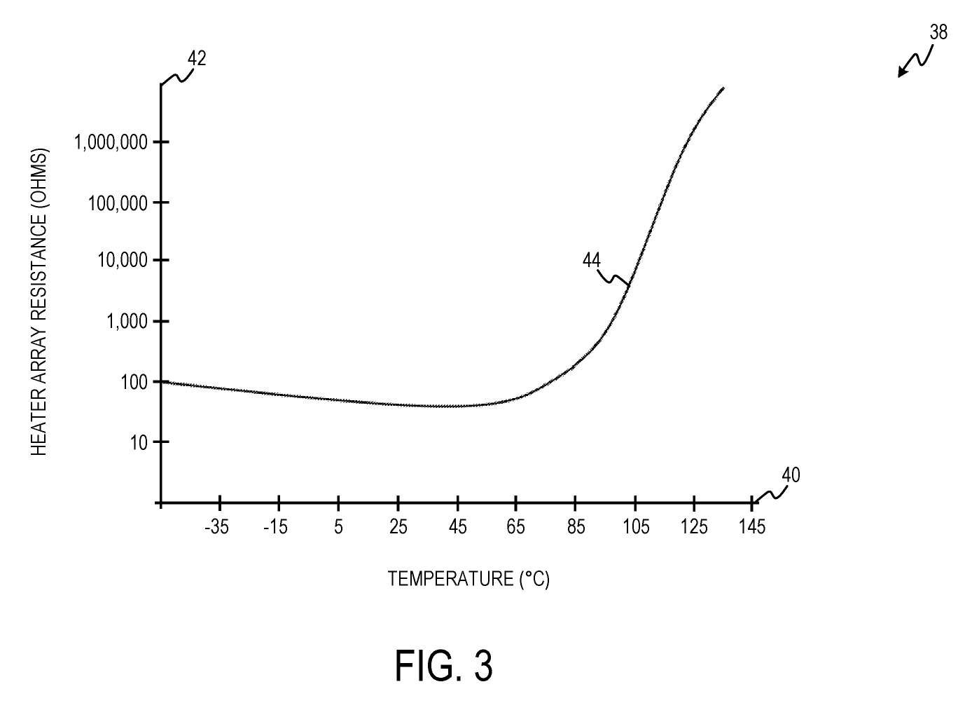

FIG. 3 is graph 38 illustrating the change in resistance of a barium titanate heater array, such as heater array 30, over temperature. Graph 38 plots temperature in degrees Celsius on x-axis 40 and heater array resistance on y-axis 42. Curve 44 shows the resistance of a barium titanate heater over temperature. As shown, y-axis 42 is logarithmic. Curve 44 begins to slope upwards significantly at about 73 degrees Celsius. Significantly above the 73 degrees Celsius set point temperature the current through a barium titanate heater array would be very small, and would likely be below a threshold current level of a monitoring system or sensor, such as sensor 24. Temperatures of this magnitude can be encountered, for example, when an aircraft is in hot conditions such as in the Middle East, or other desert regions.

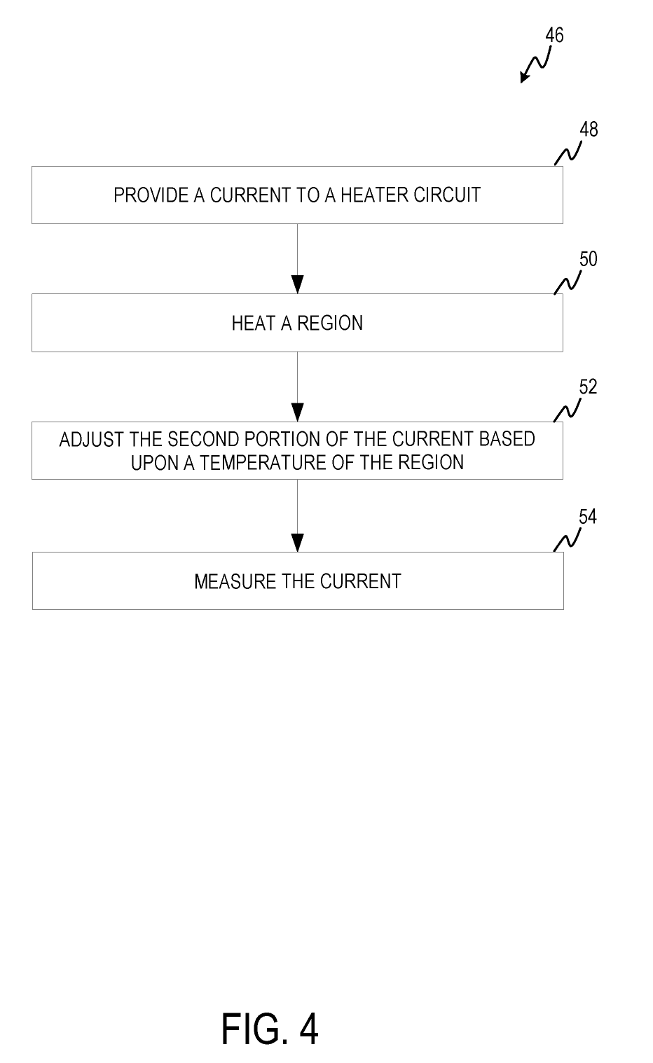

FIG. 4 is a flow diagram depicting process 46 for current compensation of a heater circuit. For purposes of clarity and ease of discussion, the example operations are described below within the context of heating system 20 of FIG. 2.

At step 48, current is provided to heater circuit 26 using voltage source 22. A first portion of the current is provided to heater array 30 of heater circuit 26. A second portion of the current is provided to compensation circuit 32. At step, 50 a region is heated using the heater array. At step 52, the second portion of the current is adjusted based upon the temperature of the region. As temperature of the region increases the first portion of the current is decreased by heater array 30. The second portion of the current is increased using the compensation circuit in response to the temperature of the region increasing. In one example, thermistor 34 decreases in resistance in response to the temperature of the region increasing, thereby increasing the second portion of the current. The second portion of the current is limited using current limiting resistor 36. In one example, current limiting resistor limits the second portion of the current to half of a current threshold level. In a further example, current limiting resistor is configured to have a substantially constant resistance. At step 54, the current provided to heater circuit 26 is measured using current sensor 24. In one example, current sensor 24 is configured to provide an alert in response to the measured current falling below the threshold current level.

Accordingly, implementing techniques of this disclosure, self-regulating heater compensation using a compensation circuit allows current monitoring without false alarms due to high temperature conditions. Using the compensation circuit described herein, a self-regulating heater can be used in conjunction with a current monitor. This helps to prevent false alarms, thereby preventing lost time and money due to the false alarms.

### Discussion of Possible Embodiments

The following are non-exclusive descriptions of possible embodiments of the present invention.

A heating system can comprise a voltage source configured to provide a current; a heater circuit electrically coupled to the voltage source, the heater circuit can comprise a heater array configured to provide heat to a region using the current; and a compensation circuit electrically coupled to the voltage source in parallel with the heater array, the compensation circuit configured to maintain the current above a threshold current level when the heater array is operable; and a current sensor configured to measure a level of the current to the heater circuit and output an alert in response to the current falling below the threshold current level.

The heating system of the preceding paragraph can optionally include, additionally and/or alternatively, any one or more of the following features, configurations and/or additional components:

The compensation circuit can comprise a thermistor; and a current limiting resistor electrically coupled to the thermistor in series, the current limiting resistor configured to prevent the current from rising above the threshold current level when the heater array is inoperable.

The thermistor can be a negative temperature coefficient thermistor.

The current limiting resistor can be configured to limit current flowing therethrough to half the current threshold level.

A resistance of the current limiting resistor can be configured to remain substantially constant.

The heater array can be a barium titanate heater array.

The region can be at least a portion of an angle of attack sensor.

The current sensor can be a shunt resistor.

A method can comprise providing a current to a heater circuit using a voltage source, can include providing a first portion of the current to a heater array of the heater circuit; and providing a second portion of the current to a compensation circuit of the heater circuit connected in parallel to the heater array; heating a region using the heater array; adjusting, using the compensation circuit, the second portion of the current based on a temperature of the region, such that a sum of the first portion of the current and the second portion of the current corresponding to the current provided to the heater circuit is maintained above a threshold current level when the heater array is operable; and measuring the current using a current sensor.

The method of the preceding paragraph can optionally include, additionally and/or alternatively, any one or more of the following features, configurations and/or additional components:

Adjusting the second portion of the current can include increasing the second portion of the current using a thermistor of the compensation circuit; and limiting the second portion of the current using a resistor of the compensation circuit, the resistor in series with the thermistor.

The thermistor can be a negative temperature coefficient thermistor.

The resistor can be configured to limit the second portion of the current to half the current threshold level.

A resistance of the resistor can be configured to remain substantially constant.

The heater array can be a barium titanate heater array.

The region can be at least a portion of an angle of attack sensor.

The current sensor can be a shunt resistor.

Providing an alert in response to the measured current falling below the threshold current level.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A heating system comprising:
a voltage source configured to provide a current;
a heater circuit electrically coupled to the voltage source, the heater circuit comprising:
a heater array configured to provide heat to a region using the current; and
a compensation circuit electrically coupled to the voltage source in parallel with the heater array, the compensation circuit configured to maintain the current above a threshold current level when the heater array is operable; and
a current sensor configured to measure a level of the current to the heater circuit and output an alert in response to the current falling below the threshold current level.

2. The heating system of claim 1, wherein the compensation circuit comprises:
a thermistor; and
a current limiting resistor electrically coupled to the thermistor in series, the current limiting resistor configured to prevent the current from rising above the threshold current level when the heater array is inoperable.

3. The heating system of claim 2, wherein the thermistor is a negative temperature coefficient thermistor.

4. The heating system of claim 2, wherein the current limiting resistor is configured to limit current flowing therethrough to half the current threshold level.

5. The heating system of claim 2, wherein a resistance of the current limiting resistor is configured to remain substantially constant.

6. The heating system of claim 1, wherein the heater array is a barium titanate heater array.

7. The heating system of claim 1, wherein the region is at least a portion of an angle of attack sensor.

8. The heating system of claim 1, wherein the current sensor is a shunt resistor.

9. A method comprising:
providing a current to a heater circuit using a voltage source, including:
providing a first portion of the current to a heater array of the heater circuit; and
providing a second portion of the current to a compensation circuit of the heater circuit connected in parallel to the heater array;
heating a region using the heater array;
adjusting, using the compensation circuit, the second portion of the current based on a temperature of the region, such that a sum of the first portion of the current and the second portion of the current corresponding to the current provided to the heater circuit is maintained above a threshold current level when the heater array is operable; and
measuring the current using a current sensor.

10. The method of claim 9, wherein adjusting the second portion of the current includes:
increasing the second portion of the current using a thermistor of the compensation circuit; and
limiting the second portion of the current using a resistor of the compensation circuit, the resistor in series with the thermistor.

11. The method of claim 10, wherein the thermistor is a negative temperature coefficient thermistor.

12. The method of claim 10, wherein the resistor is configured to limit the second portion of the current to half the current threshold level.

13. The method of claim 10, wherein a resistance of the resistor is configured to remain substantially constant.

14. The method of claim 9, wherein the heater array is a barium titanate heater array.

15. The method of claim 9, wherein the region is at least a portion of an angle of attack sensor.

16. The method of claim 9, wherein the current sensor is a shunt resistor.

17. The method of claim 9, further comprising providing an alert in response to the measured current falling below the threshold current level.
